(19) United States
(12) Patent Application Publication
(10) Pub. No.: US 2023/0028042 A1
(43) Pub. Date: Jan. 26, 2023

(54) AUGMENTED PSEUDO-LABELING FOR OBJECT DETECTION LEARNING WITH UNLABELED IMAGES

(71) Applicant: Canoo Technologies Inc., Torrance, CA (US)

(72) Inventors: Jongmoo Choi, Gardena, CA (US); Mayukh Sattiraju, Redondo Beach, CA (US); David R. Arft, Torrance, CA (US)

(21) Appl. No.: 17/808,038

(22) Filed: Jun. 21, 2022

Related U.S. Application Data
(60) Provisional application No. 63/224,261, filed on Jul. 21, 2021.

(51) Int. Cl. G06V 10/774; G06V 20/70; G06V 20/56; G06V 20/59

(52) U.S. Cl. CPC G06V 10/7753; G06V 20/70; G06V 20/56; G06V 20/59

(57) ABSTRACT

A method includes obtaining an image of a scene and identifying one or more labels for one or more objects captured in the image. The method also includes generating one or more domain-specific augmented images by modifying the image, where the one or more domain-specific augmented images are associated with the one or more labels. In addition, the method includes training or retraining a machine learning model using the one or more domain-specific augmented images and the one or more labels. Generating the one or more domain-specific augmented images may include at least one of modifying the image to include a different amount of motion blur, modifying the image to include a different lighting condition, and modifying the image to include a different weather condition.

### CROSS-REFERENCE TO RELATED APPLICATION AND PRIORITY CLAIM

This application claims priority under 35 U.S.C. § 119(e) to U.S. Provisional Patent Application No. 63/224,261 filed on Jul. 21, 2021. This provisional application is hereby incorporated by reference in its entirety.

### TECHNICAL FIELD

This disclosure relates generally to object detection systems. More specifically, this disclosure relates to augmented pseudo-labeling for object detection learning with unlabeled images.

### BACKGROUND

Identifying nearby, moving, or other objects in a scene is often an important or useful function in many autonomous applications, such as in vehicles supporting advanced driving assist system (ADAS) or autonomous driving (AD) features, or other applications. Current state-of-the-art object detectors often utilize machine learning-based perception models, such as deep learning models, that are trained to identify and classify objects captured in images of scenes. Unfortunately, it is very difficult to provide reliable and dependable perception measurements in various conditions using machine learning models. In part, this is because training data for machine learning models does not contain all possible scenes and objects in those scenes. It is impractical to assume that a fixed-size training dataset contains all future unseen objects in all possible scene conditions. As a result, many autonomous systems have been deployed with imperfect machine learning-based object detectors. To mitigate problems with these object detectors, autonomous systems are often deployed with additional sensors like light detection and ranging (LIDAR) sensors or multi-camera systems, which are more reliable but also more expensive.

### SUMMARY

This disclosure provides augmented pseudo-labeling for object detection learning with unlabeled images.

In a first embodiment, a method includes obtaining an image of a scene and identifying one or more labels for one or more objects captured in the image. The method also includes generating one or more domain-specific augmented images by modifying the image, where the one or more domain-specific augmented images are associated with the one or more labels. In addition, the method includes training or retraining a machine learning model using the one or more domain-specific augmented images and the one or more labels.

In a second embodiment, an apparatus includes at least one processor configured to obtain an image of a scene and identify one or more labels for one or more objects captured in the image. The at least one processor is also configured to generate one or more domain-specific augmented images by modifying the image, where the one or more domain-specific augmented images are associated with the one or more labels. The at least one processor is further configured to train or retrain a machine learning model using the one or more domain-specific augmented images and the one or more labels.

In a third embodiment, a non-transitory machine-readable medium contains instructions that when executed cause at least one processor to obtain an image of a scene and identify one or more labels for one or more objects captured in the image. The medium also contains instructions that when executed cause the at least one processor to generate one or more domain-specific augmented images by modifying the image, where the one or more domain-specific augmented images are associated with the one or more labels. The medium further contains instructions that when executed cause the at least one processor to train or retrain a machine learning model using the one or more domain-specific augmented images and the one or more labels.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example system supporting augmented pseudo-labeling for object detection learning with unlabeled images according to this disclosure;

FIG. 2 illustrates an example architecture supporting augmented pseudo-labeling for object detection learning with unlabeled images according to this disclosure;

FIGS. 3A through 3D illustrate an example augmented pseudo-labeling for object detection learning with an unlabeled image according to this disclosure;

FIG. 4 illustrates another example augmented pseudo-labeling for object detection learning with an unlabeled image according to this disclosure;

FIG. 5 illustrates an example design flow for employing one or more tools to design hardware that implements one or more functions according to this disclosure; and

FIG. 6 illustrates an example device supporting execution of one or more tools to design hardware that implements one or more functions according to this disclosure.

### DETAILED DESCRIPTION

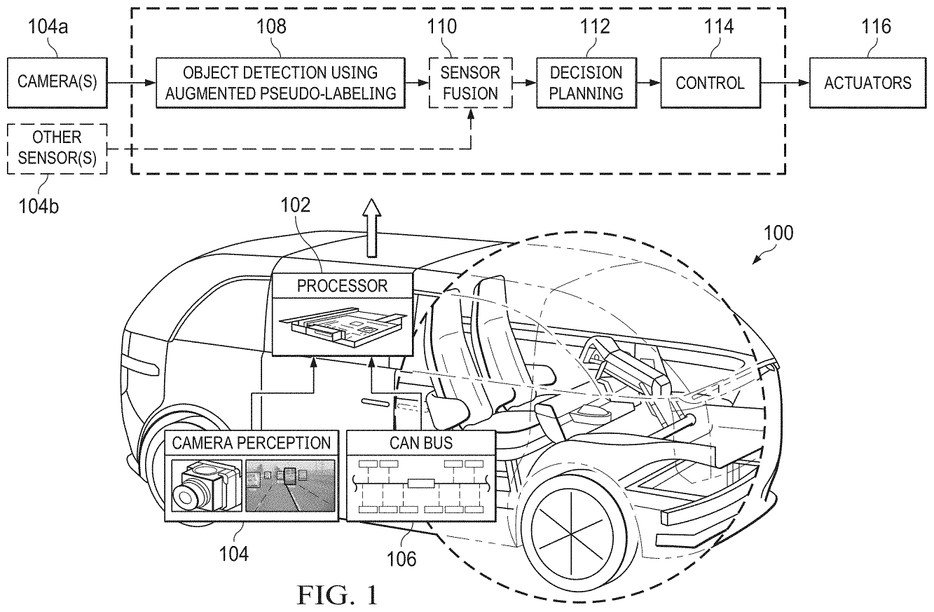

FIGS. 1 through 6, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

As noted above, identifying nearby, moving, or other objects in a scene is often an important or useful function in many autonomous applications, such as in vehicles supporting advanced driving assist system (ADAS) or autonomous driving (AD) features, or other applications. Current state-of-the-art object detectors often utilize machine learning-based perception models, such as deep learning models, that are trained to identify and classify objects captured in images of scenes. Unfortunately, it is very difficult to provide reliable and dependable perception measurements in various conditions using machine learning models. In part, this is because training data for machine learning models does not contain all possible scenes and objects in those scenes. It is impractical to assume that a fixed-size training dataset contains all future unseen objects in all possible scene conditions. As a result, many autonomous systems have been deployed with imperfect machine learning-based object detectors. To mitigate problems with these object detectors, autonomous systems are often deployed with additional sensors like light detection and ranging (LIDAR) sensors or multi-camera systems, which are more reliable but also more expensive.

This disclosure provides techniques for using augmented pseudo-labeling with unlabeled images to improve the accuracy of a machine learning-based object detection model. As described in more detail below, these techniques can capture or otherwise obtain one or more unlabeled images and apply pseudo-labeling to the captured image(s). The pseudo-labeling identifies one or more initial annotations or labels for one or more objects captured in the image(s). These techniques can also generate one or more additional or augmented images by applying image processing to the captured image(s), such as by applying motion blur, changing lighting conditions, and/or changing weather conditions within the image(s). The same label(s) for the one or more objects captured in the captured image(s) can be used for the object(s) captured in the augmented image(s). Retraining of the machine learning-based object detection model or training of a new machine learning-based object detection model may then occur using at least the label(s) and the augmented images.

In this way, machine learning-based object detection may be improved using the described “augmented pseudo-labeling” techniques. Additional details of these techniques are provided below. Note that these techniques may be implemented in any suitable manner. In some cases, these techniques may be implemented within an autonomous system or other system itself, meaning within the device or system that uses the retrained/newly-trained machine learning model. In other cases, these techniques may be implemented within a server or other system that provides a retrained/newly-trained machine learning model to an autonomous system or other system for use.

FIG. 1 illustrates an example system 100 supporting augmented pseudo-labeling for object detection learning with unlabeled images according to this disclosure. In this particular example, the system 100 takes the form of an automotive vehicle, such as an electric vehicle. However, any other suitable system may support augmented pseudo-labeling for object detection learning with unlabeled images, such as other types of vehicles, autonomous robots, or other autonomous or non-autonomous systems.

As shown in FIG. 1, the system 100 includes at least one processor 102 configured to control one or more operations of the system 100. In this example, the processor 102 may interact with one or more sensors 104 and with one or more components coupled to a bus 106. In this particular example, the one or more sensors 104 include one or more cameras or other imaging sensors, and the bus 106 represents a controller area network (CAN) bus. However, the processor 102 may interact with any additional sensor(s) and communicate over any other or additional bus(es).

The sensors 104 here include one or more cameras 104a that generate images of scenes around and/or within the system 100. The images are used by the processor 102 or other component(s) as described below to perform object detection and augmented pseudo-labeling in order to support object detection learning. In some cases, the sensors 104 may include a single camera 104a, such as one camera positioned on the front of a vehicle. In other cases, the sensors 104 may include multiple cameras 104a, such as one camera positioned on the front of a vehicle, one camera positioned on the rear of the vehicle, and two cameras positioned on opposite sides of the vehicle. In still other cases, the sensors 104 may include at least one camera 104a configured to capture images of scenes around the vehicle and/or at least one camera 104a configured to capture images of scenes within the vehicle.

The processor 102 can process the images from the one or more cameras 104a in order to detect objects around, proximate to, or within the system 100, such as one or more vehicles, obstacles, or people near the system 100 or a driver of the system 100. The processor 102 can also process the images from the one or more cameras 104a in order to perceive lane-marking lines or other markings on a road, floor, or other surface. The processor 102 can further use various information to generate predictions associated with the system 100, such as to predict the future path(s) of the system 100 or other vehicles, identify a center of a lane in which the system 100 is traveling, or predict the future locations of objects around the system 100. In addition, the processor 102 can process the images from the one or more cameras 104a to support training or retraining of at least one machine learning model used for object detection. Note that these or other functions may occur using the images from the one or more cameras 104a, possibly along with other information from one or more other types of sensors 104b. For instance, other types of sensors 104b that may be used in the system 100 could include one or more radio detection and ranging (RADAR) sensors, light detection and ranging (LIDAR) sensors, other types of imaging sensors, or inertial measurement units (IMUs).

In this example, the processor 102 performs an object detection function 108, which generally involves identifying objects around or within the system 100 in a real-time manner. For example, the object detection function 108 can use images from one or more cameras 104a to identify external objects around the system 100, such as other vehicles moving around or towards the system 100 or pedestrians or objects near the system 100. The object detection function 108 may also or alternatively identify internal objects within the system 100, such as by identifying a body and head of a driver of the system 100. The object detection function 108 can also identify one or more characteristics of each of one or more detected objects, such as an object class (a type of object) and a boundary around the detected object. As noted in FIG. 1, the object detection function 108 supports the use of an augmented pseudo-labeling function, which can identify labels for objects in captured images and generate augmented images that represent modified versions of the captured images (but with the same or similar object labels). At least the augmented images and the labels can optionally be used for retraining of one or more machine learning models or for training of one or more new machine learning models used by the object detection function 108.

The processor 102 may also optionally perform a sensor fusion function 110, which generally involves combining measurements from different sensors 104 and/or combining information about the same objects from the object detection function 108. For example, the sensor fusion function 110 may combine estimated locations or other information about the same object determined using images or other data from multiple sensors 104. The sensor fusion function 110 may combine measurements from different sensors 104 and/or information derived based on measurements from different sensors 104 in any suitable manner as needed or desired.

Information from the object detection function 108 and/or the sensor fusion function 110 (and possibly information from one or more other sources) may be provided to a decision planning function 112, which generally uses this information to determine how to adjust the operation of the system 100. For example, in an automotive vehicle, the decision planning function 112 may determine whether (and how) to change the steering direction of the vehicle, whether (and how) to apply the brakes or accelerate the vehicle, or whether (and how) to trigger an audible, visible, haptic, or other warning. The warning may indicate that the system 100 is near another vehicle, obstacle, or person, is departing from a current lane in which the vehicle is traveling, or is approaching a possible impact location with another vehicle, obstacle, or person. As another example, one or more characteristics of the driver (such as body position or head position/viewing direction) may be used by the decision planning function 112 to support driver monitoring, such as to detect if the driver appears drowsy or distracted and to trigger an audible, visible, haptic, or other warning to notify the driver. In general, the identified adjustments determined by the decision planning function 112 can vary widely based on the specific application.

The decision planning function 112 can interact with one or more control functions 114, each of which can be used to adjust or control the operation of one or more actuators 116 in the system 100. For example, in an automotive vehicle, the one or more actuators 116 may represent one or more brakes, electric motors, or steering components of the vehicle, and the control function(s) 114 can be used to apply or discontinue application of the brakes, speed up or slow down the electric motors, or change the steering direction of the vehicle. In general, the specific way(s) in which detected objects can be used may vary depending on the specific system 100 in which object detection is being used.

Note that the functions 108-114 shown in FIG. 1 and described above may be implemented in any suitable manner in the system 100. For example, in some embodiments, various functions 108-114 may be implemented or supported using one or more software applications or other software instructions that are executed by at least one processor 102. In other embodiments, at least some of the functions 108-114 can be implemented or supported using dedicated hardware components. In general, the functions 108-114 described above may be performed using any suitable hardware or any suitable combination of hardware and software/firmware instructions.

The processor 102 itself may also be implemented in any suitable manner, and the system 100 may include any suitable number(s) and type(s) of processors or other processing devices in any suitable arrangement. Example types of processors 102 that may be used here include one or more microprocessors, microcontrollers, digital signal processors (DSPs), application specific integrated circuits (ASICs), field programmable gate arrays (FPGAs), or discrete circuitry. Each processor 102 may also have any suitable number of processing cores or engines. In some cases, multiple processors 102 or multiple processing cores or engines in one or more processors 102 may be used to perform the functions 108-114 described above. This may allow, for instance, the processor(s) 102 to be used to process multiple images and other sensor data in parallel.

Although FIG. 1 illustrates one example of a system 100 supporting augmented pseudo-labeling for object detection learning with unlabeled images, various changes may be made to FIG. 1. For example, various functions and components shown in FIG. 1 may be combined, further subdivided, replicated, omitted, or rearranged and additional functions and components may be added according to particular needs. Also, as noted above, the functionality for object detection may be used in any other suitable system, and the system may or may not relate to automotive vehicles or other vehicles. In addition, the system 100 is described above as being used to perform both (i) object detection and (ii) augmented pseudo-labeling in order to support object detection learning. However, it is also possible for different devices or systems to perform these functions separately. For instance, a server or other system may receive images (possibly captured by the system 100) and perform augmented pseudo-labeling in order to support object detection learning, and the server or other system may provide one or more trained machine learning models to the system 100 and other systems for use by the object detection function 108.

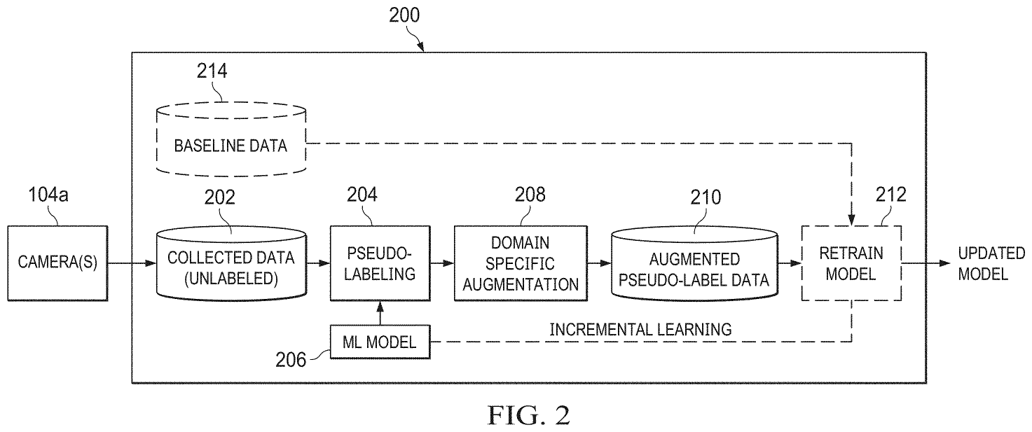

FIG. 2 illustrates an example architecture 200 supporting augmented pseudo-labeling for object detection learning with unlabeled images according to this disclosure. More specifically, the example architecture 200 shown in FIG. 2 may be used to implement at least part of the object detection function 108 described above. For ease of explanation, the architecture 200 of FIG. 2 is described as being used in the system 100 of FIG. 1. However, the architecture 200 of FIG. 2 may be used in any other suitable device or system, such as any other suitable device or system supporting or using object detection.

As shown in FIG. 2, the architecture 200 receives or otherwise obtains collected data 202 from one or more cameras 104a, where the collected data 202 includes unlabeled images captured by the one or more cameras 104a. For example, the collected data 202 may include images captured using one or more cameras 104a positioned on the front, rear, side(s), and/or inside of a vehicle. Note that if multiple images are received, the images may represent discrete images or images captured as part of a video sequence. Optionally, the images may be pre-processed, such as to remove motion blur, radial distortions, or other distortions or optical effects from the images.

The architecture 200 includes a pseudo-labeling function 204, which generally operates to perform object detection and initial labeling of detected objects. The pseudo-labeling function 204 may use any suitable technique to identify objects in the collected data 202 and to identify labels for the detected objects. In some cases, the pseudo-labeling function 204 uses a machine learning algorithm or a computer vision algorithm, which may involve the use of one or more trained machine learning models 206. In particular embodiments, the pseudo-labeling function 204 uses a deep learning network with tunable parameters to perform object detection and labeling.

In some embodiments, the pseudo-labeling function 204 may operate as follows. The pseudo-labeling function 204 uses an input image m as input to the machine learning model 206 and receives detection results R as output from the machine learning model 206. Using a supervised training technique or other technique, the machine learning model 206 can be trained to identify a nonlinear mapping between an input image m and desired detection results R, which can be expressed as follows:

Inference:(w₀,m)→R (1)

Here, w₀ is the initial detection model (the machine learning model 206). Note that a single input image m may contain k target objects (where k≥0), so the detection results R can be expressed as R={R₁, R₂, . . . , Rₖ}. In some cases, the i^{th} detection result Rᵢ may contain a bounding box or other boundary bᵢ representing the location of a detected object within an image. A bounding box may represent a rectangular box covering an object's boundary, such as when bᵢ=(x₁, y₁, x₂, y₂) where (x₁, y₁) and (x₂, y₂) respectively represent the top-left corner point of the box and the bottom-right corner point of the box. The i^{th} detection result Rᵢ may also contain a class name or label cᵢ of the detected object. As a result, the detection result Rᵢ may be denoted Rᵢ=(bᵢ, cᵢ). Each detection result Rᵢ may include any additional information as needed or desired, such as a detection confidence score.

A training dataset G may contain N image-desired output pairs, where each pair includes an input image mⱼ and the corresponding desired output results Rⱼ. Thus, the training dataset G may be expressed as:

G={(m₁,R₁),(m₂,R₂), . . . ,(m_{N},R_{N})} (2)

In some approaches, human annotators often create labeled data R={R₁, R₂, . . . , R_{N}} by manually identifying objects and labels for the objects in the various input images. A training process can be represented as a function from the initial machine learning model to an updated machine learning model. The training process updates the model parameters given the initial model w₀ and the training dataset G, which can be expressed as:

Train:(w₀,G)→w (3)

where w represents an updated machine learning model. After training, the trained machine learning model w can be used for inference on new data with some error.

In FIG. 2, the pseudo-labeling function 204 may initially have access to a pre-trained machine learning model 206, which may be generated as discussed above or in any other suitable manner. The machine learning model 206 is used by the pseudo-labeling function 204 during pseudo-labeling to identify objects and labels for objects in the images contained in the collected data 202. The pseudo-labeling can be defined as a mapping hₚ from an unlabeled image Uⱼ to corresponding generated labels Pⱼ, which can be expressed as follows.

Pseudo Labeling (hₚ):U→P (4)

where P is an input image U and the corresponding labels R={(bⱼ, cⱼ)} for the input image U. This mapping hₚ includes the inference from an input image Uⱼ to a set of detection results Rⱼ using the machine learning model 206, which can be expressed as:

f_{w}:U→R (5)

Thus, during operation, the pseudo-labeling function 204 receives N unlabeled images U={U₁, U₂, . . . , U_{N}} and generates a set of pseudo-labeled data P={(U₁, R₁), (U₂, R₂), . . . (U_{N}, R_{N})}, where Rⱼ=(bⱼ, cⱼ). The pseudo-labeled data P here therefore includes labels for the objects identified in the images of the collected data 202. The labels may be referred to as “pseudo” labels rather than ground truth labels (which may normally be generated by human annotators) since the pseudo-labeled data P is generated in an automated manner and has not been verified by human annotators.

The images from the collected data 202 and the labels generated by the pseudo-labeling function 204 are provided to a domain-specific augmentation function 208, which generally operates to produce augmented pseudo-labeled data 210 based on the images and the labels. The domain-specific augmentation function 208 modifies images from the collected data 202 to generate augmented images, and any suitable image processing may be performed by the domain-specific augmentation function 208 to generate the augmented images. For example, the domain-specific augmentation function 208 can modify images from the collected data 202 to include different amounts of motion blur, which may help to simulate different speeds of a vehicle or movements of a driver. The domain-specific augmentation function 208 can modify images from the collected data 202 to change the lighting conditions in the images, such as to brighten or darken the images in order to simulate different times of day. The domain-specific augmentation function 208 can modify images from the collected data 202 to change weather conditions in the images, such as by introducing more noise or other artifacts into the images in order to simulate rain/sleet/snow/other precipitation. The actual image processing performed by the domain-specific augmentation function 208 can be domain-specific, meaning the image processing can be tailored for use in a specific application (such as automotive vehicles or other applications). The labels identified by the pseudo-labeling function 204 can be used with the augmented images in order to produce augmented pseudo-labeled images, which represent modified versions of captured images that have been labeled automatically.

In some embodiments, the domain-specific augmentation function 208 may operate as follows. The domain-specific augmentation function 208 can receive an image Uⱼ from a set of unlabeled images U={(U₁, U₂, . . . , U_{N}} and provide one or more synthesized images Sⱼ, which can be expressed as:

Domain-Specific Augmentation (φ_{θ}):Uⱼ→Sⱼ (6)

where S represents a set of synthesized images Sⱼ and θ represents hyper-parameters in an augmentation algorithm. Multiple synthesized images can be generated using different augmentation algorithms or using different hyper-parameters, such as in the following manner:

Domain-Specific Augmentation (φ_{θ1},φ_{θ2},φ_{θ3}, . . . ):Uⱼ→{Sⱼ₁,Sⱼ₂,Sⱼ₃, . . . } (7)

where (φ_{θ1}, φ_{θ2}, φ_{θ3}, . . . ) represent multiple domain-specific augmentation algorithms/parameters and (Sⱼ₁, Sⱼ₂, Sⱼ₃, . . . ) represent multiple augmented images from a single source image Uⱼ. As a particular example of this, there may be two synthesized images Sⱼ₁ and Sⱼ₂ generated when motion blurs based on different sets of hyper-parameters are used in an image processing algorithm (meaning a single algorithm with different hyper-parameters). The augmented images Sⱼ can be paired with their corresponding labels Rⱼ (the detection results) by taking the label data from the source unlabeled images Uⱼ as generated by the pseudo-labeling function 204, which can be expressed as:

Label transfer: {(Uⱼ,Rⱼ)}→{(Sⱼ,Rⱼ)} (8)

Here, the generated labeled data A={(S₁, R₁), (S₂, R₂), . . . , (S_{N}, R_{N})} can be referred to as an augmented pseudo-label (APL) set, and this data A includes augmented images and their associated labels.

While various examples of different image processing operations that may be performed by the domain-specific augmentation function 208 are provided above, any number of image processing operations may occur to generate augmented images. As one particular example, the domain-specific augmentation function 208 may provide one or more geometric transformations when generating augmented images. Thus, the domain-specific augmentation function 208 may alter not only pixel values but also pixel locations when generating augmented images. In some cases, assuming a deterministic algorithm is used for a geometric transformation, the geometric transformation F(⋅) can be defined with an arbitrary invertible function that maps a pixel location in an image Uⱼ to a corresponding pixel location in an augmented image Sⱼ, which can be expressed as:

F:(x,y)→(x′,y′) (9)

This mapping can be applied for all labeled data as follows:

F′:(Uⱼ,Rⱼ)→(U′ⱼ,R′ⱼ) (10)

Here, (x′, y′) represents the new coordinates of a point in a synthesized image Sⱼ and (U′ⱼ, R′ⱼ) represents a pair of a new transformed image U′ⱼ and its corresponding transformed label results R′ⱼ. Each bounding box or other boundary in the results can be updated with the same transformation F.

The augmented pseudo-labeled data 210 (which includes the augmented images and their labels) can be used by a retraining model function 212, which generally operates to retrain the machine learning model 206 (or train a new machine learning model 206) for use by the pseudo-labeling function 204. Note that the augmented pseudo-labeled data 210 may or may not include the original images from the captured data 202 along with their labels. In some cases, the retraining model function 212 can have access to and use baseline data 214, which can represent the training data used to previously train the machine learning model 206. In that case, the retraining model function 212 can also use the baseline data 214 to retrain the machine learning model 206 or train the new machine learning model 206. If desired, the augmented pseudo-labeled data 210 can be stored as part of the baseline data 214 for use in a future iteration of the process shown in FIG. 2.

In some embodiments, the retraining model function 212 may operate as follows. Retraining is a process where the machine learning model 206 (or a new model to replace the machine learning model 206) is trained using the APL data. Often times, both the original training data G={(m₁, R₁), (m₂, R₂), . . . , (m_{N}, R_{N})} and the APL data A={(S₁, R₁), (S₂, R₂), . . . , (S_{N}, R_{N})} are used together during training, which can be expressed as:

New training data T=G∪A (11)

where G∪A represents the union of two labeled datasets. A model can then be trained using the training data T as follows:

Train:(G∪A,w)→w′ (12)

Here, the original captured images U={U₁, U₂, . . . , U_{N}} along with their labels may or may not be used as part of the training data by the retraining model function 212. Since the updated model w′ is trained with more data (|G∪A|>>|G|) and with the challenging augmented images, the model w′ can ideally outperform the initial model w. This entire process can be repeated if needed or desired to improve the machine learning model 206 continuously, periodically, intermittently, on-demand, or at any other suitable time(s).

Note that the functions 204, 208, 212 shown in FIG. 2 and described above may be implemented in any suitable manner. For example, in some embodiments, various functions 204, 208, 212 may be implemented or supported using one or more software applications or other software instructions that are executed by at least one processor 102 or other device(s). In other embodiments, at least some of the functions 204, 208, 212 can be implemented or supported using dedicated hardware components. In general, the functions 204, 208, 212 described above may be performed using any suitable hardware or any suitable combination of hardware and software/firmware instructions.

Although FIG. 2 illustrates one example of an architecture 200 supporting augmented pseudo-labeling for object detection learning with unlabeled images, various changes may be made to FIG. 2. For example, various functions shown in FIG. 2 may be combined, further subdivided, replicated, omitted, or rearranged and additional functions may be added according to particular needs. Also, while the functions are described as being performed within the object detection function 108 of the system 100, different functions may be performed by different components. For instance, a server or other external system may generate the labels and augmented images, train or retrain a model 206, and provide the retrained or new model 206 to the system 100 (with or without using images captured by a camera 104a of the system 100).

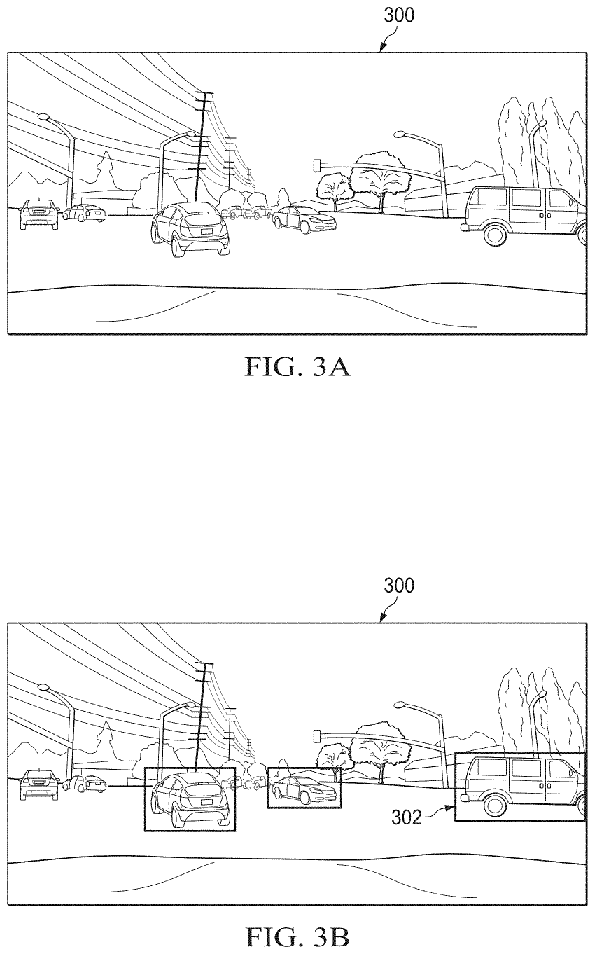

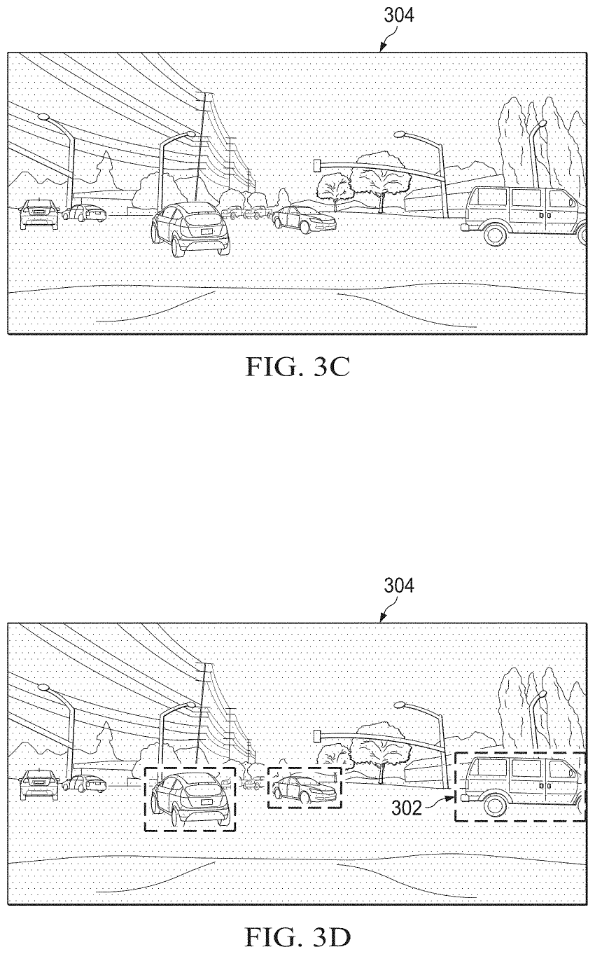

FIGS. 3A through 3D illustrate an example augmented pseudo-labeling for object detection learning with an unlabeled image according to this disclosure. For ease of explanation, the example shown in FIGS. 3A through 3D is described as being used in the system 100 of FIG. 1. However, the example shown in FIGS. 3A through 3D may be used in any other suitable device or system, such as any other suitable device or system supporting or using object detection.

As shown in FIGS. 3A and 3B, an original unlabeled image 300 is obtained (such as from a camera 104a), and a label 302 is generated for each of one or more detected objects in the image 300. In this example, each label 302 is represented as a bounding box, although other boundaries may be used. Also, as noted above, each label 302 may include or be associated with an object class (which may identify a type of object), a confidence score, or any other or additional information. Each label 302 here may be generated by the pseudo-labeling function 204 based on the current machine learning model 206.

As shown in FIGS. 3C and 3D, an augmented image 304 can be generated and associated with the same labels 302 as the original image 300. Here, the augmented image 304 may be produced by the domain-specific augmentation function 208 and may represent part of the augmented pseudo-labeled data 210. In this example, the image 300 has been darkened and the appearance of rain has been added to create the augmented image 304. Note that if a geometric transformation occurs as part of the domain-specific augmentation function 208 to generate the augmented image 304, the boundaries defined by the labels 302 can also be transformed. By performing this type of process with a number of images 300 and a number of possible image modifications to the images 300, it is possible to generate a challenging set of pseudo-labeled training data for retraining the model 206 or generating a new model 206.

Although FIGS. 3A through 3D illustrate one example of an augmented pseudo-labeling for object detection learning with an unlabeled image, various changes may be made to FIGS. 3A through 3D. For example, any type(s) and number(s) of objects may be identified and pseudo-labeled in the original image 300 and the augmented image 304. Also, scene contents can vary widely, and FIGS. 3A through 3D are merely meant to illustrate one example of how an unlabeled image may be labeled with pseudo-labels and used to generate an augmented image with the same or similar pseudo-labels.

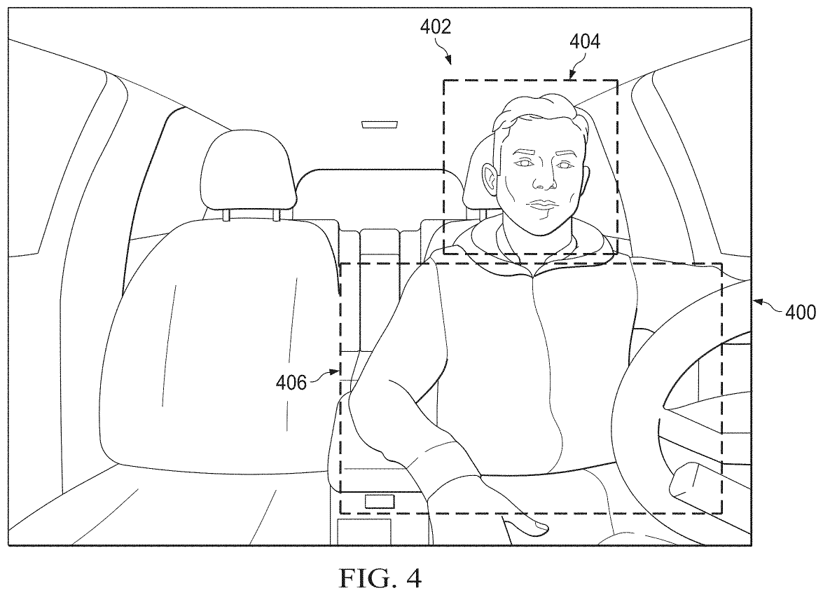

FIG. 4 illustrates another example augmented pseudo-labeling for object detection learning with an unlabeled image according to this disclosure. For ease of explanation, the example shown in FIG. 4 is described as being used in the system 100 of FIG. 1. However, the example shown in FIG. 4 may be used in any other suitable device or system, such as any other suitable device or system supporting or using object detection.

As shown in FIG. 4, an original image 400 is obtained, such as from a camera 104a. In this example, the image 400 captures a scene within a vehicle, including a driver 402 of the vehicle. Labels 404-406 are generated for different detected objects in the image 400, where the objects in this example represent a head and a body of the driver 402. Each label 404-406 is represented as a bounding box, although other boundaries may be used. Also, as noted above, each label 404-406 may include or be associated with an object class (which may identify a type of object, such as type of body part), a confidence score, or any other or additional information. Each label 404-406 here may be generated by the pseudo-labeling function 204 based on the current machine learning model 206.

One or more augmented images can be generated and associated with the same labels 404-406 as the original image 400. For example, one or more augmented images may be produced by the domain-specific augmentation function 208 and may represent part of the augmented pseudo-labeled data 210. As particular examples, one or more augmented images may be darkened or brightened, and/or the appearance of smoke or other contents in the air may be added to create the augmented image(s). Note that if a geometric transformation occurs as part of the domain-specific augmentation function 208 to generate the augmented image(s), the boundaries defined by the labels 404-406 can also be transformed. Again, by performing this type of process with a number of images 400 and a number of possible image modifications to the images 400, it is possible to generate a challenging set of pseudo-labeled training data for retraining the model 206 or generating a new model 206.

Although FIG. 4 illustrates another example of an augmented pseudo-labeling for object detection learning with an unlabeled image, various changes may be made to FIG. 4. For example, any type(s) and number(s) of objects may be identified and pseudo-labeled in the original image 400 and the augmented image(s). Also, scene contents can vary widely, and FIG. 4 is merely meant to illustrate another example of how an unlabeled image may be labeled with pseudo-labels and used to generate an augmented image with the same or similar pseudo-labels.

Note that many functional aspects of the embodiments described above can be implemented using any suitable hardware or any suitable combination of hardware and software/firmware instructions. In some embodiments, at least some functional aspects of the embodiments described above can be embodied as software instructions that are executed by one or more unitary or multi-core central processing units or other processing device(s). In other embodiments, at least some functional aspects of the embodiments described above can be embodied using one or more application specific integrated circuits (ASICs). When implemented using one or more ASICs, any suitable integrated circuit design and manufacturing techniques may be used, such as those that can be automated using electronic design automation (EDA) tools. Examples of such tools include tools provided by SYNOPSYS, INC., CADENCE DESIGN SYSTEMS, INC., and SIEMENS EDA.

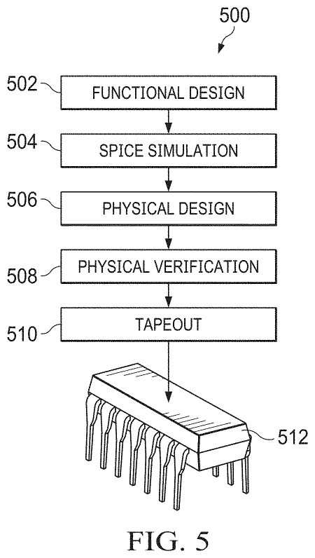

FIG. 5 illustrates an example design flow 500 for employing one or more tools to design hardware that implements one or more functions according to this disclosure. More specifically, the design flow 500 here represents a simplified ASIC design flow employing one or more EDA tools or other tools for designing and facilitating fabrication of ASICs that implement at least some functional aspects of the various embodiments described above.

As shown in FIG. 5, a functional design of an ASIC is created at step 502. For any portion of the ASIC design that is digital in nature, in some cases, this may include expressing the digital functional design by generating register transfer level (RTL) code in a hardware descriptive language (HDL), such as VHDL or VERILOG. A functional verification (such as a behavioral simulation) can be performed on HDL data structures to ensure that the RTL code that has been generated is in accordance with logic specifications. In other cases, a schematic of digital logic can be captured and used, such as through the use of a schematic capture program. For any portion of the ASIC design that is analog in nature, this may include expressing the analog functional design by generating a schematic, such as through the use of a schematic capture program. The output of the schematic capture program can be converted (synthesized), such as into gate/transistor level netlist data structures. Data structures or other aspects of the functional design are simulated, such as by using a simulation program with integrated circuits emphasis (SPICE), at step 504. This may include, for example, using the SPICE simulations or other simulations to verify that the functional design of the ASIC performs as expected.

A physical design of the ASIC is created based on the validated data structures and other aspects of the functional design at step 506. This may include, for example, instantiating the validated data structures with their geometric representations. In some embodiments, creating a physical layout includes “floor-planning,” where gross regions of an integrated circuit chip are assigned and input/output (I/O) pins are defined. Also, hard cores (such as arrays, analog blocks, inductors, etc.) can be placed within the gross regions based on design constraints (such as trace lengths, timing, etc.). Clock wiring, which is commonly referred to or implemented as clock trees, can be placed within the integrated circuit chip, and connections between gates/analog blocks can be routed within the integrated circuit chip. When all elements have been placed, a global and detailed routing can be performed to connect all of the elements together. Post-wiring optimization may be performed to improve performance (such as timing closure), noise (such as signal integrity), and yield. The physical layout can also be modified where possible while maintaining compliance with design rules that are set by a captive, external, or other semiconductor manufacturing foundry of choice, which can make the ASIC more efficient to produce in bulk. Example modifications may include adding extra vias or dummy metal/diffusion/poly layers.

The physical design is verified at step 508. This may include, for example, performing design rule checking (DRC) to determine whether the physical layout of the ASIC satisfies a series of recommended parameters, such as design rules of the foundry. In some cases, the design rules represent a series of parameters provided by the foundry that are specific to a particular semiconductor manufacturing process. As particular examples, the design rules may specify certain geometric and connectivity restrictions to ensure sufficient margins to account for variability in semiconductor manufacturing processes or to ensure that the ASICs work correctly. Also, in some cases, a layout versus schematic (LVS) check can be performed to verify that the physical layout corresponds to the original schematic or circuit diagram of the design. In addition, a complete simulation may be performed to ensure that the physical layout phase is properly done.

After the physical layout is verified, mask generation design data is generated at step 510. This may include, for example, generating mask generation design data for use in creating photomasks to be used during ASIC fabrication. The mask generation design data may have any suitable form, such as GDSII data structures. This step may be said to represent a “tape-out” for preparation of the photomasks. The GDSII data structures or other mask generation design data can be transferred through a communications medium (such as via a storage device or over a network) from a circuit designer or other party to a photomask supplier/maker or to the semiconductor foundry itself. The photomasks can be created and used to fabricate ASIC devices at step 512.

Although FIG. 5 illustrates one example of a design flow 500 for employing one or more tools to design hardware that implements one or more functions, various changes may be made to FIG. 5. For example, at least some functional aspects of the various embodiments described above may be implemented in any other suitable manner.

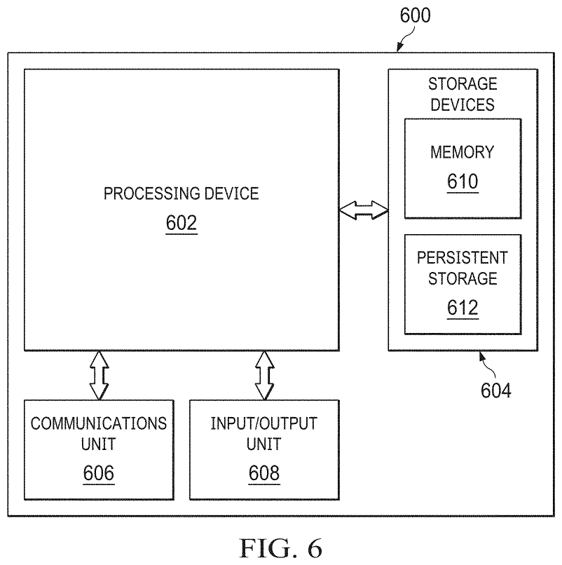

FIG. 6 illustrates an example device 600 supporting execution of one or more tools to design hardware that implements one or more functions according to this disclosure. The device 600 may, for example, be used to implement at least part of the design flow 500 shown in FIG. 5. However, the design flow 500 may be implemented in any other suitable manner.

As shown in FIG. 6, the device 600 denotes a computing device or system that includes at least one processing device 602, at least one storage device 604, at least one communications unit 606, and at least one input/output (I/O) unit 608. The processing device 602 may execute instructions that can be loaded into a memory 610. The processing device 602 includes any suitable number(s) and type(s) of processors or other processing devices in any suitable arrangement. Example types of processing devices 602 include one or more microprocessors, microcontrollers, DSPs, ASICs, FPGAs, or discrete circuitry.

The memory 610 and a persistent storage 612 are examples of storage devices 604, which represent any structure(s) capable of storing and facilitating retrieval of information (such as data, program code, and/or other suitable information on a temporary or permanent basis). The memory 610 may represent a random access memory or any other suitable volatile or non-volatile storage device(s). The persistent storage 612 may contain one or more components or devices supporting longer-term storage of data, such as a read only memory, hard drive, Flash memory, or optical disc.

The communications unit 606 supports communications with other systems or devices. For example, the communications unit 606 can include a network interface card or a wireless transceiver facilitating communications over a wired or wireless network. The communications unit 606 may support communications through any suitable physical or wireless communication link(s).

The I/O unit 608 allows for input and output of data. For example, the I/O unit 608 may provide a connection for user input through a keyboard, mouse, keypad, touchscreen, or other suitable input device. The I/O unit 608 may also send output to a display or other suitable output device. Note, however, that the I/O unit 608 may be omitted if the device 600 does not require local I/O, such as when the device 600 represents a server or other device that can be accessed remotely.

The instructions that are executed by the processing device 602 include instructions that implement at least part of the design flow 500. For example, the instructions that are executed by the processing device 602 may cause the processing device 602 to generate or otherwise obtain functional designs, perform simulations, generate physical designs, verify physical designs, perform tape-outs, or create/use photomasks (or any combination of these functions). As a result, the instructions that are executed by the processing device 602 support the design and fabrication of ASIC devices or other devices that implement one or more functions described above.

Although FIG. 6 illustrates one example of a device 600 supporting execution of one or more tools to design hardware that implements one or more functions, various changes may be made to FIG. 6. For example, computing and communication devices and systems come in a wide variety of configurations, and FIG. 6 does not limit this disclosure to any particular computing or communication device or system.

In some embodiments, various functions described in this patent document are implemented or supported using machine-readable instructions that are stored on a non-transitory machine-readable medium. The phrase “machine-readable instructions” includes any type of instructions, including source code, object code, and executable code. The phrase “non-transitory machine-readable medium” includes any type of medium capable of being accessed by one or more processing devices or other devices, such as a read only memory (ROM), a random access memory (RAM), a Flash memory, a hard disk drive (HDD), or any other type of memory. A “non-transitory” medium excludes wired, wireless, optical, or other communication links that transport transitory electrical or other signals. Non-transitory media include media where data can be permanently stored and media where data can be stored and later overwritten.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining an image of a scene;
identifying one or more labels for one or more objects captured in the image;
generating one or more domain-specific augmented images by modifying the image, the one or more domain-specific augmented images associated with the one or more labels; and
training or retraining a machine learning model using the one or more domain-specific augmented images and the one or more labels.

2. The method of claim 1, wherein:
identifying the one or more labels comprises identifying the one or more labels using an initial machine learning model; and
training or retraining the machine learning model comprises retraining the initial machine learning model.

3. The method of claim 1, wherein generating the one or more domain-specific augmented images comprises at least one of:
modifying the image to include a different amount of motion blur;
modifying the image to include a different lighting condition; and
modifying the image to include a different weather condition.

4. The method of claim 1, wherein generating the one or more domain-specific augmented images comprises applying at least one geometric transformation to the image and to the one or more labels.

5. The method of claim 1, further comprising:
using the machine learning model to perform object detection.

6. The method of claim 1, wherein:
the image of the scene captures a scene around a vehicle; and
the one or more objects captured in the image comprise one or more objects around the vehicle.

7. The method of claim 1, wherein:
the image of the scene captures a scene within a vehicle; and
the one or more objects captured in the image comprise one or more portions of a driver's body.

8. An apparatus comprising:
at least one processor configured to:
obtain an image of a scene;
identify one or more labels for one or more objects captured in the image;
generate one or more domain-specific augmented images by modifying the image, the one or more domain-specific augmented images associated with the one or more labels; and
train or retrain a machine learning model using the one or more domain-specific augmented images and the one or more labels.

9. The apparatus of claim 8, wherein:
the at least one processor is configured to identify the one or more labels using an initial machine learning model; and
the at least one processor is configured to train or retrain the initial machine learning model using the one or more domain-specific augmented images and the one or more labels.

10. The apparatus of claim 8, wherein, to generate the one or more domain-specific augmented images, the at least one processor is configured to at least one of:
modify the image to include a different amount of motion blur;
modify the image to include a different lighting condition; and
modify the image to include a different weather condition.

11. The apparatus of claim 8, wherein, to generate the one or more domain-specific augmented images, the at least one processor is configured to apply at least one geometric transformation to the image and to the one or more labels.

12. The apparatus of claim 8, wherein the at least one processor is further configured to use the machine learning model to perform object detection.

13. The apparatus of claim 8, wherein:
the image of the scene captures a scene around a vehicle; and
the one or more objects captured in the image comprise one or more objects around the vehicle.

14. The apparatus of claim 8, wherein:
the image of the scene captures a scene within a vehicle; and
the one or more objects captured in the image comprise one or more portions of a driver's body.

15. A non-transitory machine-readable medium containing instructions that when executed cause at least one processor to:
obtain an image of a scene;
identify one or more labels for one or more objects captured in the image;
generate one or more domain-specific augmented images by modifying the image, the one or more domain-specific augmented images associated with the one or more labels; and
train or retrain a machine learning model using the one or more domain-specific augmented images and the one or more labels.

16. The non-transitory machine-readable medium of claim 15, wherein:
the instructions that when executed cause the at least one processor to identify the one or more labels comprise:
instructions that when executed cause the at least one processor to identify the one or more labels using an initial machine learning model; and
the instructions that when executed cause the at least one processor to train or retrain the machine learning model comprise:
instructions that when executed cause the at least one processor to retrain the initial machine learning model.

17. The non-transitory machine-readable medium of claim 15, wherein the instructions that when executed cause the at least one processor to generate the one or more domain-specific augmented images comprise:
instructions that when executed cause the at least one processor to at least one of:
modify the image to include a different amount of motion blur;
modify the image to include a different lighting condition; and
modify the image to include a different weather condition.

18. The non-transitory machine-readable medium of claim 15, wherein the instructions that when executed cause the at least one processor to generate the one or more domain-specific augmented images comprise:
instructions that when executed cause the at least one processor to apply at least one geometric transformation to the image and to the one or more labels.

19. The non-transitory machine-readable medium of claim 15, further containing instructions that when executed cause the at least one processor to use the machine learning model to perform object detection.

20. The non-transitory machine-readable medium of claim 15, wherein:
the image of the scene captures a scene around a vehicle; and
the one or more objects captured in the image comprise one or more objects around the vehicle.

21. The non-transitory machine-readable medium of claim 15, wherein:
the image of the scene captures a scene within a vehicle; and
the one or more objects captured in the image comprise one or more portions of a driver's body.
